(19) United States
(12) Patent Application Publication
(10) Pub. No.: US 2004/0006900 A1
(43) Pub. Date: Jan. 15, 2004

(54) Ornament display device

(76) Inventor: Michael G. Beller, Powell, OH (US)

Correspondence Address: Francis T. Kremblas Jr., 7632 Slate Ridge Blvd., Reynoldsburg, OH, 43068, US

(21) Appl. No.: 10/193,083

(22) Filed: Jul. 10, 2002

(51) Int. Cl. G09F 3/00; G09F 15/00; G09F 3/16

(52) U.S. Cl. 40/329; 40/666; 40/608

(57) ABSTRACT

An ornament display device configured to be mounted on a button or similar shaped member found on the top of conventional hats or the like. The display device of the present invention includes a base configured to be releasably mounted over the button, a flexible stem mounted on the top of the base and extending upwardly, and an ornament or signage member mounted on the upper end of the stem. The device of the present invention permits the ornament or signage member to be removably mounted on a convention athletic hat or cap in a highly visible manner attracting attention to the displayed ornament.

### CROSS-REFERENCE TO RELATED APPLICATIONS

(Not applicable)

### STATEMENT REGARDING FEDERALLY SPONSORED RESEARCH OR DEVELOPMENT

(Not Applicable)

### REFERENCE TO A “MICROFICHE APPENDIX”

(Not Applicable)

### BACKGROUND OF THE INVENTION

1. Field of Invention

The present invention relates generally to an ornament display device which can be mounted upon a substrate, and particularly. to such a device which is adapted to be mounted upon the button located on the top of conventional hats or caps, such as, for example, baseball or golf hats.

2. Background of Related Art

The prior art includes many types of devices which can be mounted upon various types of headgear, including those which can be mounted to the button located on the top of conventional baseball or golf hats.

Representative examples of prior art designs include U.S. Pat. No. 5,896,585; U.S. Pat. No. 155,437; U.S. Pat. No. 2,679,711; U.S. Pat. No. 2,958,156; U.S. Pat. No. 3,098,316; and U.S. Pat. No. 3,216,149.

However, none of these patents teach or suggest the novel arrangement and combination disclosed in the present invention which provides advantageous features as described herein.

### BRIEF SUMMARY OF THE DISCLOSURE

The present invention relates to a display device for ornamental or novelty images or serving as a carrier for signage or brief messages. The display device may be conveniently mounted on the button of a conventional baseball or golf hat or the like, as well as be adapted for mounting on other surfaces, such as an automobile dashboard, for example. As used herein, the term ornament, sign, or signage member may be used interchangeably to define the same component of the present invention irrespective of the descriptive purpose of the member.

The present invention comprises a base configured to removably receive a button of the type conventionally found on the top of athletic or sporting type hats and caps and includes an elongate flexible stem connected at its lower end to the base and extending vertically upward. An ornament or signage member is mounted on the upper end of the flexible stem to accentuate the display of the ornament or signage member.

As one aspect of the present invention, a preferred embodiment includes a base provided with a top wall having an upwardly extending collar for connecting to the lower end of the stem and includes downwardly depending side walls terminating in a resilient rim which may be in the form of a plurality of resilient fingers. The resilient rim may be mounted on or removed from the button.

In another aspect of the present invention, the stem may be in the form of an elongated coil spring. The flexibility of the spring selected controls the amount of movement which is imparted to the ornament or signage member upon movement of the hat or other surface upon which the display device is mounted.

It is an additional aspect of the present invention to optionally provide a suction cup which is provided with a button-like protrusion of its top surface which is adapted to be received by the base in a similar manner to the button on the top of a hat or cap. This permits the display device to be conveniently mounted on a different substrate surfaces, such as an auto dashboard, or a table, for example.

It is a further aspect of the present invention to provide a display device of the type described which incorporate desirable features such as referred to herein and yet is of relatively low cost manufacture and allows multiple forms of ornaments or signage members to be interchangeably displayed in a highly visible, attention attracting manner.

### BRIEF DESCRIPTION OF THE DRAWINGS

FIG. 1 is a top plan view of a display device constructed in accordance with the present invention with a representative sign or message plate shown in ghost lines;

FIG. 2 is a side elevational view of the device shown in FIG. 1;

FIG. 3 is a bottom plan view of the device shown in the preceding figures;

FIG. 4 is a side elevational view similar to FIG. 2 further including a conventional hat disposed with the top button aligned with the bottom of the base of the display device to illustrate a ready to be mounted position;

FIG. 5 is a side elevational view, in section, illustrating the base portion of the device in its mounted position over the button of the hat shown in FIG. 4; the section being taken along the centerline of the base;

FIG. 6 is a side elevational view of another embodiment of the present invention illustrating the device shown in FIGS. 1-3 aligned above a suction cup having an upper collar adapted to be received within the base of the display device; and

FIG. 7 is a side elevational view, in section, illustration the base mounted over the button-like collar provided on the suction cup shown in FIG. 5 to provide an assembly mountable on a generally flat substrate surface.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

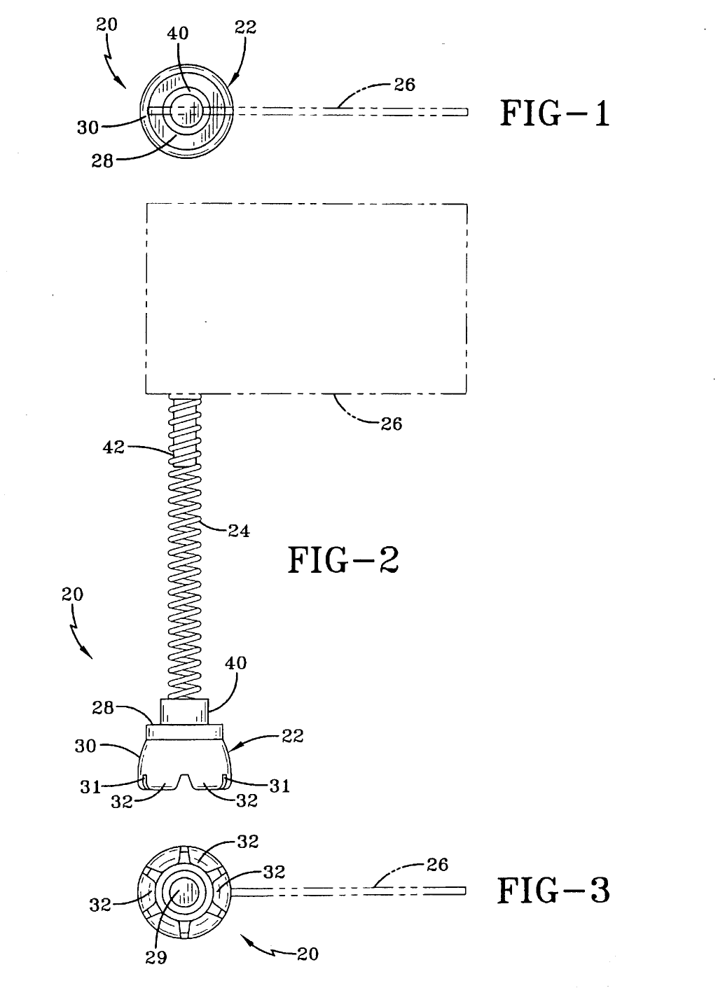

One preferred embodiment of an ornament or signage member display device, constructed in accordance with the present invention is illustrated in FIGS. 1-3. The device indicated generally at 20, includes a base 22, a flexible stem 24, and an ornament member 26. The ornament member 26 may take several forms such as, for example, a team logo, a company trademark, or a message plate carrying printed indicia or a combination thereof. Additionally, the message plate may be provided with a writing surface wherein individual messages may be provided as desired.

Examples of particular ornaments or signage having particular popularity may include college or professional athletic team logos, promotional trademarks, or forms of novelty images or humorous messages similar to bumper stickers on vehicles.

With reference to FIGS. 1-3, base 22 may comprise a molded plastic part having a top surface 28 and downwardly depending side walls 30 forming an interior recess 29. Side walls 30 may include slots or openings 31 to form a plurality of resilient fingers, such as at 32, to provide a releasable mounting structure for receiving the conventional button 34 provided on the top 36 of baseball or golfing hat 38, such as shown in FIG. 4.

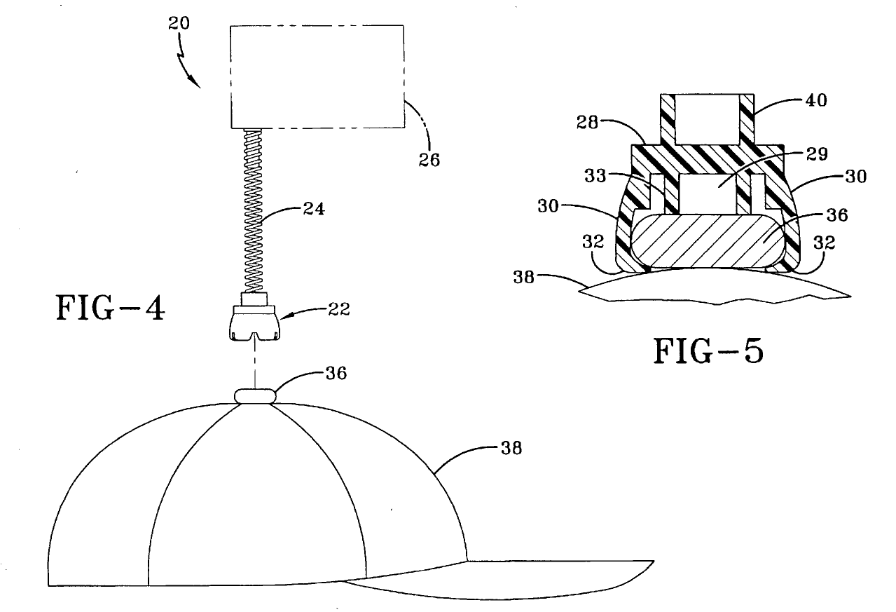

It will be understood that the plurality of fingers 32 shown may be substituted by other equivalent means to releasably attach base 22 to the bottom 36 including but not limited to, for example, a similar shaped one piece flange, not shown, which possesses a similar degree of resiliency as provided by fingers 32 to enable base 22 to be pushed downwardly and snap over button 34 with the curved end portion of fingers 32, or the one piece flange, being moved outwardly over the lower edge of button 34 and then spring inwardly toward its original, normal position to engage a portion of the lower surface of button 34 in a force-transmitting relationship, such as illustrated in FIG. 5.

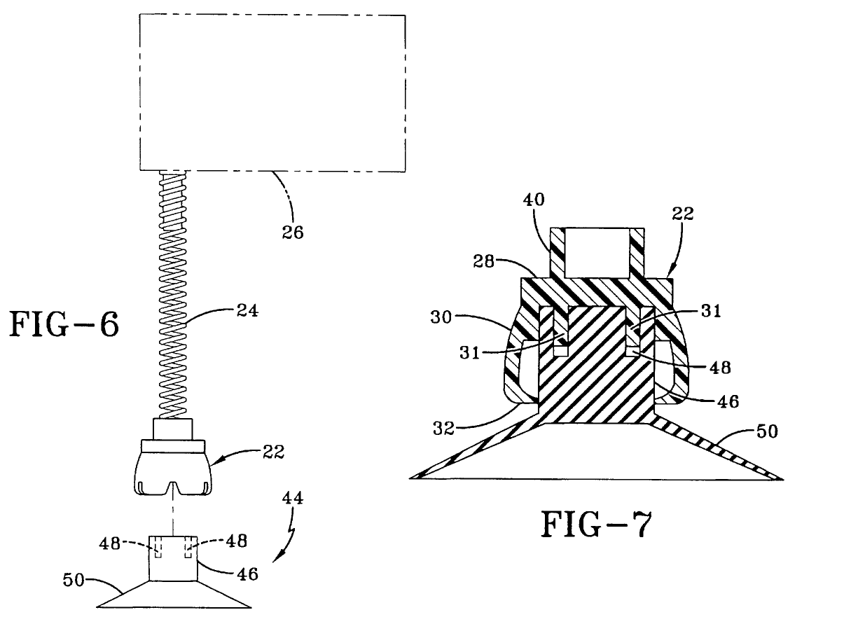

Interior recess 29 may be formed to limit the degree button 34 may be accepted within recess 29 by including a stop such as downwardly depending posts 33 which also may be advantageous for use with another embodiment of the present invention shown in FIGS. 6 and 7 as described in detail later herein.

However, other conventional forms of a stop for limiting the depth a button, such as 34, may enter recess 29 may be used without departing from the spirit of the present invention. It should be noted that selectively limiting the depth button 34 enters recess 29 tends to more effectively grasp button 34 between resilient fingers 32 to more securely hold base 22 on button 34.

The top surface 28 of base 22 includes a collar portion 40 having a top opening configured to fixedly receive the lower portion of stem 24 in a friction-fit or press-fit relationship. However, the lower end of stem 24 may be fixed to the upper surface of base 22 in any suitable conventional manner well-known to those skilled in the art without departing from the spirit of the present invention.

In the preferred embodiment shown, flexible stem 24 is in the form of an elongate coil spring which may comprise a suitable metal or plastic material and be formed with a selected degree of flexibility to allow a range of movement to be imparted to member 26 upon movement of the hat or other substrate surface upon which device 20 is mounted.

In many applications a significant degree of flexibility is desirable to attract attention to the ornament or signage member by its movement. Typically, the flexibility would not be so great as to render stem 24 incapable of returning to or initially assuming an essentially vertical disposition. Using a coil spring configuration is desirable over other forms as it permits a relatively convenient form to select and control the degree of flexibility. Further, the coil spring configuration inherently includes an opening at both ends which can be conveniently sized to be received within the opening in collar 40 as well as receive a tab-like extension 42 provided on ornament or signage member 26 as described later herein.

The ornament or signage member 26 may be fixed to the upper end of stem 22 in any suitable well-known manner. A preferred means is shown in FIG. 1 wherein the ornament is in the form of a generally rectangular plate comprising a sheet material, such as plastic or metal. An example of a popular ornament is one simulating the flag of the United States of America. However the other forms or shapes may also be employed, such as a logo image of a Major League Baseball or other professional sports team may be advantageously employed. The lower edge of the member 26 is provided with a downwardly depending tab-like extension 42 configured to be friction fit into the central opening formed in the upper end stem 24. As should be understood and well-known to those skilled in the art, other forms and shapes may be used for member 28, such as spherical, rectangular or specific outline images. A sheet or plate-like member is preferred for member 28 because a wide variety of ornamental or signage display in a simple and inexpensive manner.

A further embodiment of the display device of the present invention is illustrated in FIGS. 6 and 7. The only difference shown in this embodiment relates to the addition of a suction cup element 44 to the display device 20 described above herein.

Suction cup 44 functions to permit display device 20 to be mounted on a relatively flat or level substrate, such as a table, wall, or automobile dashboard, for example.

Suction cup 44 may be formed from an integrally molded resilient plastic material and be provided with an upstanding, generally cylindrical tubular collar 26 which has a diameter slightly greater than the opening to the recess 29 defined by the ends of fingers 32.

As noted earlier herein, the earlier described downwardly depending posts 31 within recess 29 serve a dual purpose when combined with suction cup 44 wherein the collar 46 includes a pair of bores 48 adapted to receive posts 31 in a light press fit to complement the resilient engagement of fingers 32 with collar 46 to hold cup 44 within recess 29 of base 22. Suction cup 44 includes a hollow conical base 50 which is sufficiently flexible to allow base 50 to be pressed downwardly upon a generally flat substrate to create a negative air pressure within base 50 in the well-known conventional manner readily understood by one of ordinary skill to create a suction effect to releasably mount base 50 upon a generally planar substrate.

Therefore, in this embodiment of the present invention, the display device of the present invention may readily be mounted on a automotive dashboard, for example, to display the ornament member 26 in a similar manner as when it is mounted on a hat or cap as earlier described to provide alternative options to the user.

In view of the foregoing description, it should be readily understood that the display device of the present invention provides new and useful advantages over the prior art. The present invention provides a relatively simple and inexpensive construction which offers a wide variety of ornaments, signs or specific images to be attractively displayed in an attention-getting manner. It is highly advantageous for novelty and humorous purposes, as well as for advertising promotions or more serious messages, including images reflecting a show of patriotism which has gained popularity in view of the events over the past year.

While certain preferred embodiments of the present invention have been disclosed in detail, it is to be understood that various modifications may be adopted without departing from the spirit of the invention or scope of the following claims.

1. An ornament display device adapted to be removably mounted upon conventional hats or caps which include a generally round button fixed to the top thereof, comprising, in combination;
a) a base configured for releasable engagement with a generally round button;
b) an elongate flexible stem having first and second ends opposing one another, said first end connected to said base and said second end extending vertically away from said base; and
c) an ornament member connected to said second end of said flexible stem and disposed vertically above said base.

2. The display device defined in claim 1 wherein said base includes a recess provided with a downwardly facing opening configured to receive said button in a releasably fixed relationship.

3. The ornament display device defined in claim 2 wherein said opening in said lower recess is surrounded by a plurality of downwardly directly resilient fingers having inwardly curved lower ends, and has a diameter less than the diameter of said button, whereby said curved lower ends may be forced outwardly over an upper surface of said button and resiliently return inwardly into engagement with a lower surface of said button.

4. The ornament display device defined in claim 1 wherein said base includes an upper wall provided with vertically extending collar and downwardly depending side walls forming a bottom facing recess, said collar including a top opening configured to receive the lower end of said elongate stem in a fixed relationship; said side walls having inwardly curved lower ends configured to releasably receive said button in a force-transmitting relationship within said recess.

5. The ornament display device defined in claim 1 wherein said elongate stem comprises a coiled spring.

6. An ornament display device adapted to be removably mounted upon an upstanding protrusion, comprising in combination;
a) a base including a recess provided with a downwardly facing opening surrounded by resilient side walls configured to releasably fixed said upstanding protrusion within said opening;
b) an elongate flexible stem fixed to and extending vertically upward from a top surface of said base; and
c) a member having a surface area configured for displaying ornamental images, messages, or other indicia connected to an upper end of said stem.

7. The display device defined in claim 6 wherein said upstanding protrusion is formed on the upper surface of a suction cup configured for releasably supporting said device upon a generally flat substrate surface.
